(19) United States
(12) Patent Application Publication
(10) Pub. No.: US 2016/0046010 A1
(43) Pub. Date: Feb. 18, 2016

(54) SYSTEM FOR ENHANCING OPERATION OF POWER TOOLS

(71) Applicant: Black & Decker Inc., Newark, DE (US)

(72) Inventors: Jason F. Busscharet, Bel air, MD (US); Craig A. Schell, Street, MD (US); Christopher Herrmann, Parkton, MD (US)

(21) Appl. No.: 14/928,470

(22) Filed: Oct. 30, 2015

Related U.S. Application Data
(63) Continuation-in-part of application No. 13/923,710, filed on Jun. 21, 2013.
(60) Provisional application No. 61/666,115, filed on Jun. 29, 2012.

(51) Int. Cl. B25F 5/00; G05B 19/04; B23Q 17/24

(52) U.S. Cl. CPC B25F 5/00; B23Q 17/2414; G05B 19/041

(57) ABSTRACT

A system for facilitating power tool operation and positioning includes a power tool, remote detectable device attached to the power tool, a computing device communicating with the power tool to detect the location of the power tool relative to the computing device by detecting the location remote detectable device, and a display for displaying or inputting information into the computing device. The computing device is able to receive and store CAD dimensional data representing a layout of a work area and specific locations in that area where work need to be done. The computing device directs a positioning of the tool at a work site by comparing the position of the tool with the CAD layout position of a location where work needs to be done.

### CROSS REFERENCE TO RELATED APPLICATION

The following application hereby incorporates by reference and derives priority from U.S. Patent Application No. 61/666,115, filed on Jun. 29, 2012, and from U.S. patent application Ser. No. 13/923,710, filed on Jun. 21, 2013, now pending.

### FIELD OF THE INVENTION

The present invention relates to a system for positioning and enhancing the operation of power tools.

### BACKGROUND

It is desirable to efficiently position and operate power tools in a jobsite, which increases productivity and lowers labor costs. Accordingly, it is an object of the invention to provide a system to increase the efficiency of power tools as used in construction situations.

### BRIEF DESCRIPTION OF THE DRAWINGS

FIG. 1 illustrates an exemplary system according to the invention.

FIG. 2 is a block diagram of the major electronic components of the exemplary system of FIG. 1.

FIG. 3 is a flowchart of different exemplary processes that can be performed by the exemplary system of FIG. 1.

FIG. 4 illustrates a visual output of the exemplary system of FIG. 1.

FIG. 5 illustrates different reference markers that can be used with the exemplary system of FIG. 1, where FIGS. 5A-5C are a right triangle marker, a circular marker and a pipe marker, respectively.

FIG. 6 shows a circular saw which can be part of the system, where

FIGS. 6A-6B are a side view seen from the perspective of line A-A in FIG. 6B and a bottom view seen from the perspective of line B-B in FIG. 6A, respectively.

FIGS. 7A-7E shows a perspective view of a hand held pole tool which may be part of the system.

FIG. 8 shows a perspective view of another embodiment of a powered tool and base which may be part of the system.

FIG. 9 shows a perspective view of another embodiment of the powered tool and base of FIG. 8.

### DESCRIPTION

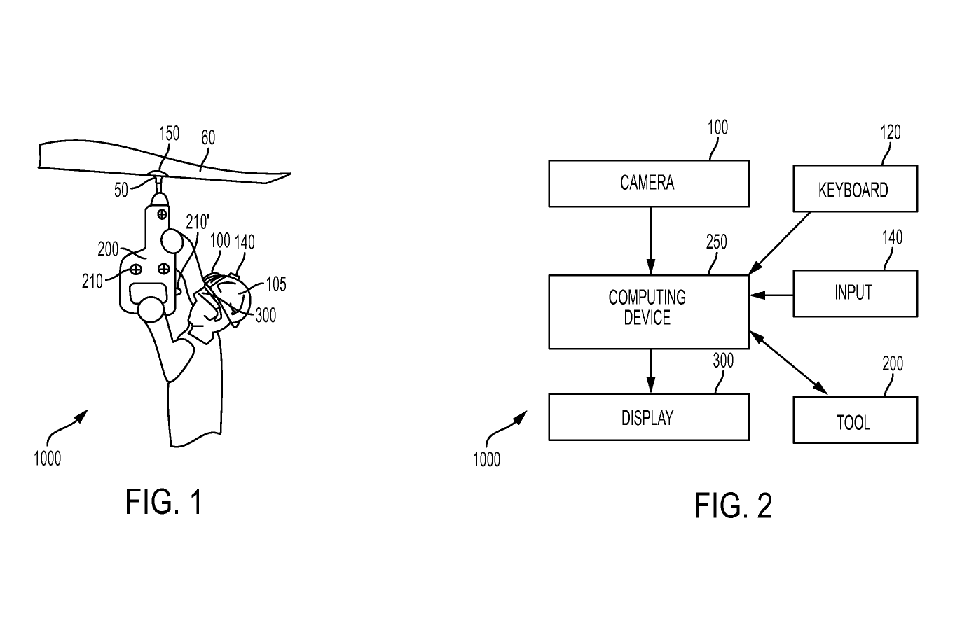

FIGS. 1-2 illustrate an exemplary system 1000 for enhancing operation of power tools or marking devices according to the invention. In particular, tools 200 may include drills, power hammers, hammer drills, pneumatic nailers, pole installers, circular saws, reciprocating saws, jigsaws, miter saws, table saws, marking device, etc. Pole installers allow for manual installation of an accessory (e.g., a concrete anchor into wood form) and marking devices may be any mechanism capable of making a visual mark or indication on a worksite capable of alerting a worker where equipment is to be installed and/or where a power tool operation (e.g., drilling a hole) should take place. While this system primarily focuses on motorized tools, the system disclosed herein can be adapted to a manual pole installer with telescopically sliding parts that deliver impacts to an accessory as discussed above.

System 1000 may also include a computing device 250, such as a personal computer, tablet, mobile telephone, smartphone, total station, etc. It is desirable that hand tools or power tools 200 be in communication with computing device 250. Preferably such communication will occur via a wireless communication system 126, such as Wi-Fi, Bluetooth, Zigbee, infrared light, RF, etc.

Computing device 250 may include a camera 100. Persons skilled in the art will recognize that camera 100 may also be separate from computing device 250. For example, camera 100 may be disposed on a tripod or a user's hard hat 105. If camera 100 is separate from computing device 250, it is preferable that communication between camera 100 and computing device 250 occur via a wireless communication system, such as Wi-Fi, Bluetooth, Zigbee, infrared light, RF, etc. Depending on the bandwidth of the wireless communication system, it may be desirable to provide camera 100 with graphic processing circuitry so as to calculate orientation vectors, simplify visual data, etc., thus minimizing the amount of data sent through the wireless communication system.

Computing device 250 may include a keyboard 120. Such keyboard 120 can be a physical keyboard on computing device 250, or a virtual keyboard shown on a display 300 of computing device 250. Persons skilled in the art will recognize that keyboard 120 may also be separate from computing device 250. If keyboard 120 is separate from computing device 250, it is preferable that communication between keyboard 120 and computing device 250 occur via a wireless communication system, such as Wi-Fi, Bluetooth, Zigbee, infrared light, RF, etc.

Persons skilled in the art will recognize that computing device 250 may receive other inputs from assorted input systems 140, such as measurements sent from a wall sensor, laser distance measurer, tape measure, etc., data received by an RFID sensor and/or QR/bar code scanners, etc. Such input systems 140 may also be separate from computing device 250. For example, an RFID sensor 140 may be disposed on a user's hard hat 105. If an input system 140 is separate from computing device 250, it is preferable that communication between input system 140 and computing device 250 occur via a wireless communication system, such as Wi-Fi, Bluetooth, Zigbee, infrared light, RF, etc.

Computing device 250 may have a display 300. Preferably such display 300 is an LED or OLED display. Display 300 may be located on tool 200. Display 300 (with or without computing device 250) could also be wearable by the user. For example, display 300 may be disposed on glasses worn by a user. Persons skilled in the art are referred to U.S. Pat. No. 8,203,502, which is wholly incorporated by reference, for further information on such display glasses (also known as head-up display).

Persons skilled in the art will recognize that display 300 may also be separate from computing device 250. If display 300 is separate from computing device 250, it is preferable that communication between display 300 and computing device 250 occur via a wireless communication system, such as Wi-Fi, Bluetooth, Zigbee, infrared light, RF, etc.

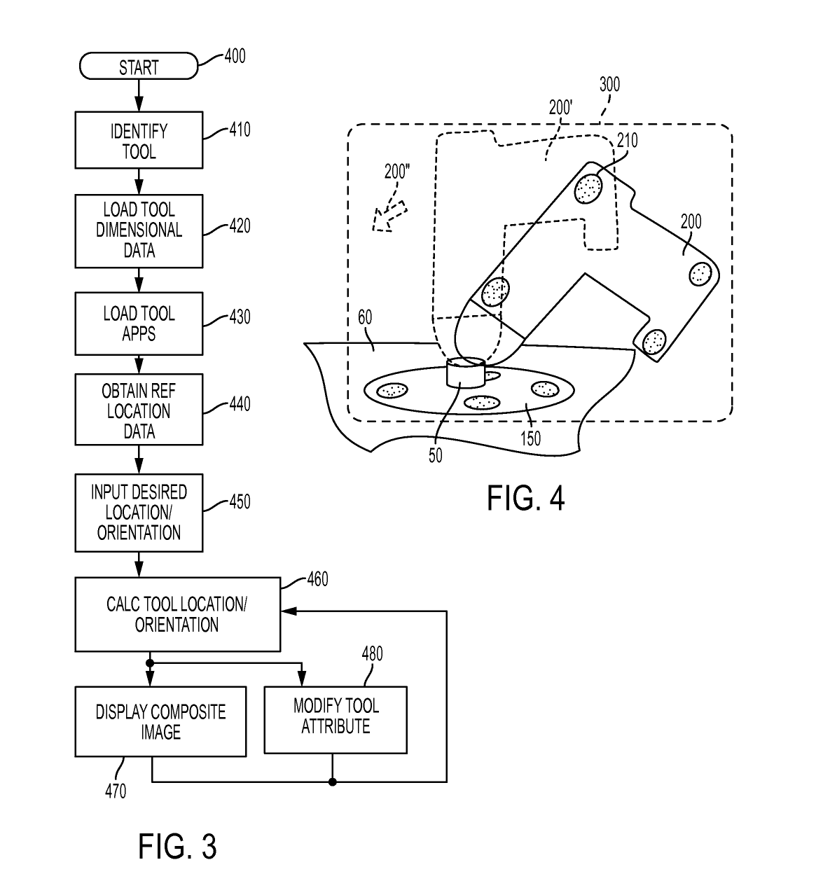

Computing device 250 may have a program or app that implements the steps shown in the flowchart of FIG. 3. A user may begin the program at step 400 by, for example, selecting the appropriate app/program on her computing device 250.

In response to such selection, computing device 250 preferably identifies at least one nearby power tool 200 (step 410). One method for identified such power tools is by pinging the different nearby power tools 200 and other products with a wireless signal, such as RFID or Bluetooth. The computing device 250 can then create an inventory of nearby power tools 200 and other products based on the responses it receives.

Alternatively, computing device 250 can get video input from the camera 100. Computing device 250 can look for QR/bar code markers 210 disposed on the power tools 200 to identify the nearby power tools 200. Persons skilled in the art will recognize that markers 210 could be QR codes, bar codes, IR markers, or other markers, such as the circular codes taught in U.S. Pat. No. 5,554,841 or the light sources taught in U.S. Pat. Nos. 5,973,788, 5,196,900, 5,440,392, 5,805,287, and 6,166,809, wholly incorporated hereby by reference.

If multiple power tools 200 or other products are identified, the user can select one of the listed power tools 200 for further use. Once the desired power tool 200 is identified and/or selected, the computing device 250 loads the dimensional data of power tool 200 into memory (step 420). Such dimensional data may include the location of different markers 210 or other topographical feature on the housing of the power tool 200, such as a bump 210′.

The computing device 250 can also load tool-specific apps (step 430). For example, if power tool 200 is a drill, impact driver or hammer, computing device 250 can load apps to input the desired drill orientation (e.g., being perpendicular to a wall surface) or depth, to input or indicate certain locations where holes should be drilled, to modify tool attributes depending upon the material to be drilled into, etc. If power tool 200 is a circular saw, computing device 250 can load apps to steer the circular saw along a particular path, to allow a limited cutting distance, to cut along a path disposed at a particular angle relative to a defined line, etc. The user can then select the desired app for the particular job task at hand.

If necessary for the particular app selected by the user, computing device 250 can obtain reference location data (step 440). This can be accomplished in multiple ways. First, computing device 250 can be provided with an electronic file representative of the construction plans, which indicate the location of different tasks, such as different areas to cut or drill, different places where anchors 50 need to be installed, etc. This data can be loaded electronically via a file transfer from another device, inputted by hand via keyboard 120, and/or by loading actual measurements taken by tape measures, distance measurers, angle measurers and other inputs 140.

Alternatively, a user may place reference markers 150 on different work surfaces. These reference markers 150 may be shaped for particular surfaces or job tasks.

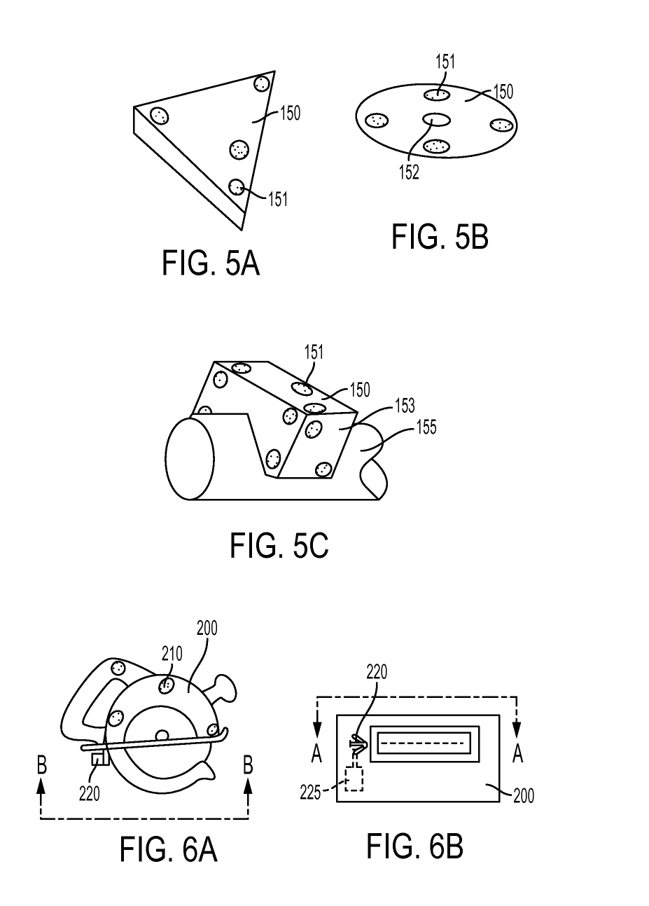

For example, if the user wants to refer to a particular edge or line, the user can place the reference marker 150 shown in FIG. 5A. If the user wants to identify a point on a surface, e.g., a point where an anchor is to be installed, the user can place a circular reference marker 150 as shown in FIG. 5B. Such circular reference marker 150 may have a center opening 152 to allow the user to drill near the center of circular reference marker 150.

Another example of a task-specific reference marker 150 is shown in FIG. 5C. Such reference marker 150 has a body 153 which can be disposed on a pipe 155.

Computing device 250 can look for QR/bar code markers 151 disposed on the reference markers 150 to identify the reference marker 150. Persons skilled in the art will recognize that markers 151 could be QR codes, bar codes, IR markers, or other markers, such as the circular codes taught in U.S. Pat. No. 5,554,841, wholly incorporated hereby by reference.

Once computing device 250 recognizes the reference marker 150, it loads up the dimensional data for the particular reference marker 150. Because computing device 250 knows the distances between markers 151, it can obtain images via camera 100 that show the markers 151, and compare the relative distances in the image to the actual known distances to calculate the orientation of the reference marker 150. Persons skilled in the art are referred to U.S. Pat. Nos. 8,179,604 and 5,973,788 wholly incorporated herein by reference, which illustrates the triangulation principles used in determining position and orientation of the reference markers 150 based on the captured visual data.

Persons skilled in the art will recognize that it is preferable that reference markers 150 have multiple markers 151, so that, even if some markers 151 are covered, there will be enough uncovered markers 151 for the computing device 250 to calculate the orientation of reference marker 150. If system 1000 uses only one camera 100, there should be enough markers 151 so that at least three markers 151 remain uncovered. If system 1000 uses more cameras 100, the number of markers 151 required to remain uncovered decreases. For example, U.S. Pat. No. 8,179,604 illustrates that only one marker 151 would be necessary in a two-camera system.

Once the orientation of the reference marker 150 is determined, computing device can create a coordinate system based on reference marker 150. In other words, once computing device 250 calculates the orientation of the circular reference marker 150 shown in FIG. 5B, it can create a coordinate system as computing device 250 knows where the center of such reference marker 150 is located.

If necessary, the user can input the desired location and/or orientation of power tool 200 relative to reference marker 150 (step 450). This can be done by inputting values into computing device 250 via a keyboard 120 or other input systems.

Because computing device 250 knows the dimensional data of power tool 200 (from step 420), the computing device 250 knows the location of different markers 210 or other topographical features on the housing of the power tool 200, such as a bump 210′. Computing device 250 can obtain images via camera 100 that show the markers 210/210′, and compare the relative distances in the image to the actual known distances to calculate the relative location and/or orientation of the power tool 200 (step 460). Persons skilled in the art will recognize that the triangulation techniques used to calculate the orientation and/or location of reference markers 150 can be used to calculate the location and/or orientation of the power tool 200.

Persons skilled in the art will recognize that it is preferable that power tool 200 have multiple markers 210, so that, even if some markers 210 are covered, there will be enough uncovered markers 210 for the computing device 250 to calculate the orientation of power tool 200. If system 1000 uses only one camera 100, there should be enough markers 210 so that at least three markers 210 remain uncovered. If system 1000 uses more cameras 100, the number of markers 210 required to remain uncovered decreases.

Depending upon the selected tool app, computing device 250 can show a composite image on display 300 as shown in FIG. 3 (step 470). In such image, the user will see the actual orientation of the power tool 200 and reference marker 150. Persons skilled in the art will recognize that it may be advantageous to replace the actual video data with a simplified version where a graphic representative of power tool 200 in its actual orientation (without showing the user's hands).

In addition, it may be advantageous to show a pale or ghost image 200′ of power tool 200 at the desired location/orientation in the composite image. In this manner, for example, the user can know to move the power tool 200 to match the orientation of the ghost image 200′ in order to ensure perpendicularity relative to surface 60. Once the orientation of the power tool 200 matches the orientation of the ghost image 200′, computing device 250 can provide an audio or visual signal to indicate that a match has been reached.

Similarly, display 300 can show other indications such as arrow 200″ to instruct the user to move the power tool 200 in a certain direction, or other visual cues, such as stop signs, etc. to communicate instructions to the user. For example, if the power tool 200 is a circular saw that is supposed to move along a desired line, arrows 200″ can be used to instruct the user to steer the circular saw to the left or right in order to make a straight cut. If the user had inputted a cut with a particular length, display 300 can show a stop sign to instruct the user to end the cut. Furthermore, using an input device such as a smart phone serving as one of the above devices (e.g., 100, 120, 140, or 300) that can talk wirelessly to computing device 250 (e.g., a total station) or directly inputting into a total station, a user may select a desired task location (e.g., a location where a hole should be drilled). The total station can receive the task location input and the total station may include a visual indicator (e.g., an articulating laser pointer that positions itself to project a light onto the work area (task location) exactly where or near where the tool is to be positioned). If multiple construction procedures (e.g., holes to be drilled at multiple task locations) are to be conducted, the remote input device (e.g., smart phone) can be used to instruct computing device 250 to advance the visual indicator pointer from one task location to the next.

For example, CAD data showing the site layout and task locations could be loaded on the handheld input device 120 and/or the computing device 250 and the user (looking at the CAD laid out site on display 300) could choose which task location to be directed to next via the above mentioned location indication concepts above (e.g., arrows, stop signs, audible alarms, voice direction, laser pointers, etc.). Furthermore, the computing device 250 could automatically direct the user to move from task location to task location via the above concepts and via a timing schedule.

Depending upon the selected tool app, computing device 250 may modify a tool attribute (step 480). Persons skilled in the art are referred to U.S. Application No. 61/664,428, filed on Jun. 26, 2012, entitled “System for Enhancing Power Tools,” which is wholly incorporated by reference, for further details on how computing device 250 modifies different tool attributes.

For example, referring to FIG. 6, if the user had inputted a particular cut with a circular saw, computing device 250 can control a rudder 220 to steer the circular saw to the left or right in order to make a straight cut. Rudder 220 can be moved by a servo 225, which is preferably controlled in real-time by computing device 250.

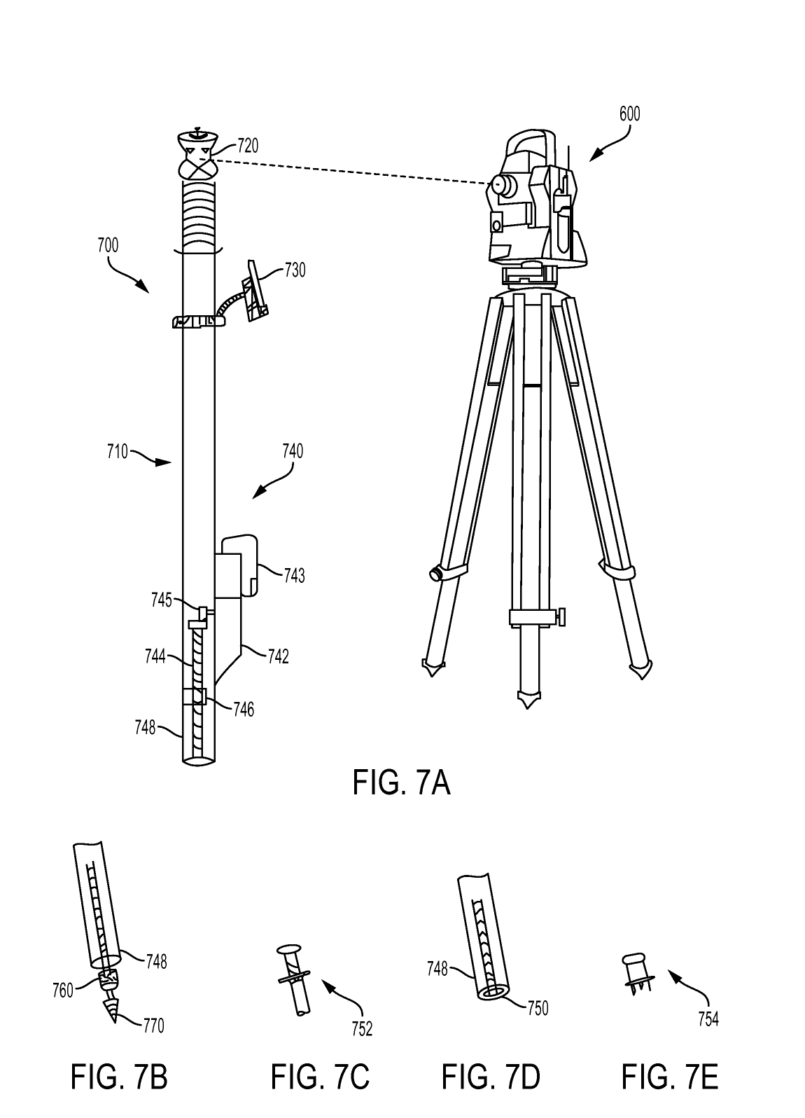

In step 410 above, the markers above are detectable by computing device 250 which may include a camera 100 so that a tool 200 on which markers are located can be identified and located. As an alternative to the tool identifying marker detection system described above, a power tool 200 may be fitted with a remotely locatable device such as a prism 280. It is well known to use a computing device 250 such as a total station in combination with a pole fitted with a prism (similar to the tool shown in FIG. 7A) to locate or confirm pole positions relative to a reference point at the total station. Furthermore, many total stations use LDM (Laser Distance Measurement) devices which are trained to track a prism to determine the location of the prism.

LDMs measure linear distance between the total station and the prism. These LDMs are typically mounted on a pair of rotary stages so the prism may be traced to any location within the range of distance and rotary stage's ranges of motion. Typically, the prism pole is used to determine the location of a mark on the ground.

Through the same known process by which an operator can determine the position of a prism pole relative the total station, an operator can also determine the location of the prismed tool 200 relative to total station 600. Specifically, total station 600 includes a computing device 250 and an LDM transmitter/sensor that works in conjunction with prism 280. The sensor could be capable of detecting a position of prism 280 and therefore a position of tool 200. If the longitudinal axis of the tool (e.g., a drill or drill bit) is perpendicular to the work-piece, it can be verified that the drill bit is at the desired work-site position (e.g., for drilling a hole or setting an anchor). Alternatively, the position of the tool bit can be calculated when the position of the prism is known by using known dimensions of the tool.

The present invention contemplates tool 200 being a linear actuation impact delivering tool or a tool that delivers a more gradual force in a linear direction (e.g., a direction of the longitudinal tool axis). Whether impact or gradual, tool 200 operates on (e.g., drill or impact) a work member such as a pre-cast anchor. FIG. 7A discloses such a linear force tool 700. Tool 700 includes an elongated body 710. Body 710 supports a signal communicating device or a target (e.g., a light manipulating target such as a prism) 720, a display 730 and a force delivery mechanism 740. Signal communication device 720 may be a prism for interacting with total station 600 for confirming the position of tool 700 relative to a position at which total station 600 is fixed as discussed above. Display 730 can receive a wireless signal from a computing device 250 such as total station 600 with information about the position of tool 700 superimposed at or over a desired location. Display 730 can also show (as mentioned above) arrows which indicate a direction tool 700 should be moved in so as to be closer to the desired location. More specifically, display 730 may include an uploaded CAD layout of desired locations superimposed with the actual location of tool 700.

Force delivery mechanism 740 could be any cordless (including battery 743) or corded mechanism that stores potential energy and then releases it quickly for impact. For example, force from a motor could contract a spring (e.g., via a crew system) storing energy to be quickly released by a trigger in order to impact an accessory such as a nail or anchor to be set. A similar impact system can be pneumatically powered. Furthermore, a tool can be powered the way some conventional nailers utilize motor powered flywheels or compressed air to trigger release an impact force. FIG. 7E shows an anchor 754 having protruding nails. The nails are to be driven into construction wood-work, the tool impact can drive the nails into the wood to set the anchor before concrete is poured. This driving might even be accomplished using tools such as the type of power hammer described in U.S. Pat. No. 8,087,472, which is wholly incorporated by reference. In the case of a hammer a prism might be secured directly to the hammer.

Alternatively, the force to be delivered to an anchor could be generated when a motor 742 rotates a male screw 744 threadably mated with a female pushing member 746 so that the female member is forced to travel axially. The axial travel of female member 746 in a direction from device 720 toward a distal end 748 can quickly and gradually force an anchor member into a predrilled opening in the metal decking. For example, FIG. 7C shows a well known metal deck concrete insert 752 such as a Bang-It™ insert.

In the above linear actuators, various mechanisms may be utilized at distal end 748 for engaging accessory equipment. For example, FIG. 7B shows a chuck 760 provided on rotating member 744 and a drilling accessory such as a bit 770 (e.g., a step bit) may be secure via the chuck 760. Furthermore, a magnet 750 (shown in FIG. 7D) or magnetic force may be used to secure anchor 752, 754 to the driving end of the tool before force is applied to the anchor. For example a distal end 748 of the tool holder of a power hammer may be magnetic or magnetized to secure the anchor in place at the tool's tool holder until a force (e.g., an impact force) drives the anchor into final desired position. Alternatively, a marking mechanism such as a spray container can be connected at a lower end of the linear actuator tool 700.

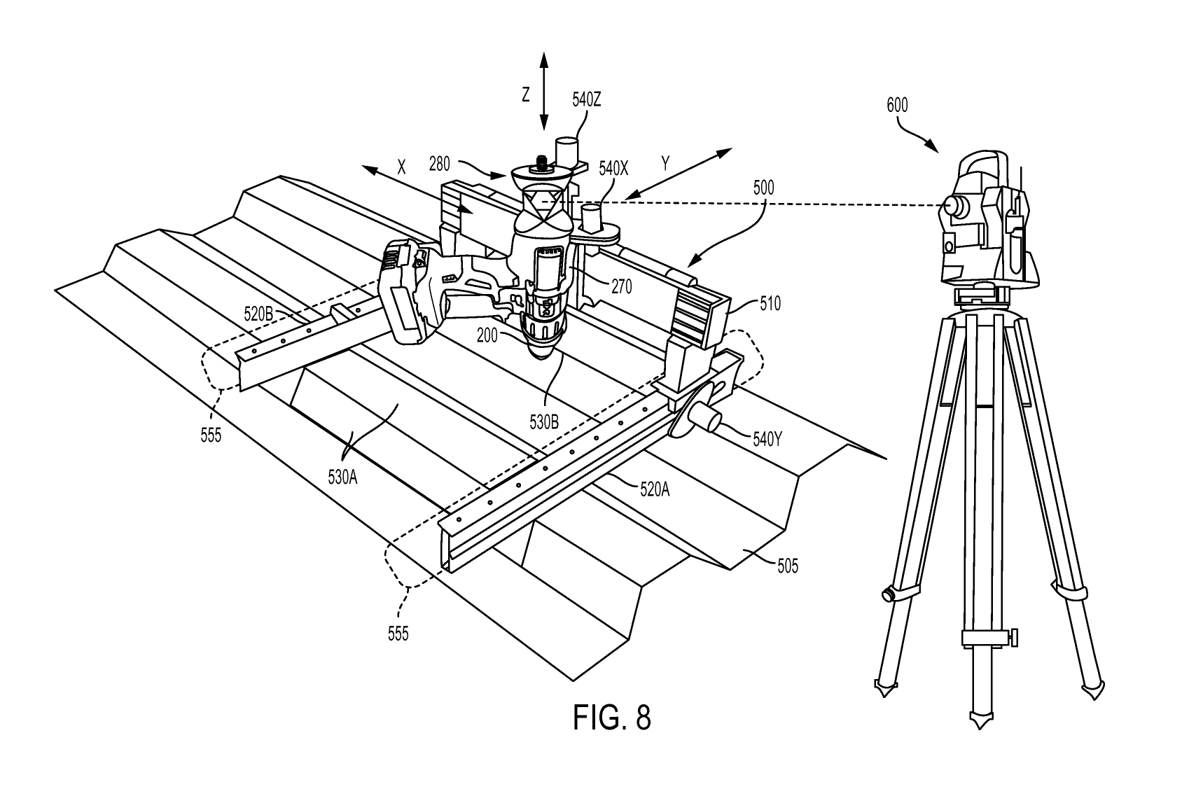

In another embodiment, FIG. 8 also shows a motorized tool 200 (e.g., a drill or hammer drill) having a linear accessory disposed along a longitudinal axis. FIG. 8 further shows signaling between a total station 600 and a prismed power tool 200. The tool accessory (e.g., a drill bit) could be for one of creating a hole or delivering an impact to a work-piece (e.g., a cast in place concrete anchor as mentioned above) and could include a prism 280 attached to tool 200. Prism 280 could be secured to tool 200 such that it is aligned with or coaxial with the accessory axis. Otherwise prism 280 could be located off axis and a special relationship between the prism and axis could be calculate.

As further shown in FIG. 8, positioning of tool 200 might also be facilitated by providing a base 500 for supporting the prismed tool 200. Base 500 could moveably supporting the tool 200 as tool 200 is automatically/selectively moved relative to base 500 along a plane of the work site decking 505. In other words, along a plane substantially perpendicular to the tool accessory axis (e.g., the longitudinal access of a drill bit). Base 500 could also be motorized so that base 500 is capable of automatically positioning tool 200 and the tool accessory at a designated point on the plane. Specifically, a user of total station 600 could tell station 600 to send a wireless position signal to base 500 where base 500 includes a receiver capable of receiving the signal from computing device 250 (e.g., a total station) and tell base 500 to position tool 200 at that specific work site location/position.

Base 500 may include parallel rails or tracks 520A, 520B that moveably interconnect with at least one cross rail or cross bar 510 (more cross bars may be used and may be interconnected with each other). Base 500 may also include motors 540X, 540Y and 540Z and rails 510 and 520 may include rack gears that cooperate with pinions on each respective ones of motors 540X, 540Y and 540Z. Tool 200 may be supported on one of cross bar(s) 510 via an adjustable bracket 270. Those skilled in the art will appreciate that in addition to rack and pinion gear mechanisms, motors 540X, 540Y and 540Z may move portions of the base relative to each other to position the tool via screw systems or belt systems. Rotation of a motor 540X may cause bracket 270 to move in an X direction relative to tracks 520 and relative to the worksite. A motor 540Y may move cross bar 510 in a Y direction relative to tracks 520 and the worksite. Furthermore, rotation of a motor 540Z will cause tool 200 and a portion of bracket 270 to move in a Z direction relative to tracks 520 and relative to the worksite (i.e., perpendicular to the positioning and working plane). As a result, operation of motors 540X, 540Y will move tool 200 in the directions X and Y respectively relative to base 500. Specifically, when tool 200 is in the desired or final (X, Y) planer position, motor 540Z can move tool 200 in the Z direction for drilling or impacts. The system may include a controller that coordinates triggering of the drill or impact driver with the downward movement of tool 200 as a result of energizing of motor 540Z. Base 500 and/or tool 200 may be cordless so that motors 540X, 540Y, and 540Z of base 500 may be powered by multi celled batteries as described above.

A wireless receiver (not shown) and a motor controller (not shown) may be included in base 500 for receiving a work site position signal from the total station and directing motors 540X, 540Y and 540Z to position a tool accessory at the work site position. Site engagement portions 530A and 530B may be provided at a lower portion of base 500 for securing base 500 to work site metal decking 505. Magnets (e.g, permanent magnets or be electromagnets selectively energized) may be incorporated into site engagement portions 530A and 530B where necessary to provide a securing force between base 500 and decking 505. Furthermore, site engagement portions 530 may be selectively shaped to conform to the peaks, valleys, sides, and inclined slopes of metal sheeting of the construction decking 505.

Base 500 may be of any size. However, if base 500 is not of sufficient size to cover all of the jobsite locations where tool 200 is to perform an operation, base 500 may need to be periodically relocated to the areas of need. The tool positioning system disclosed herein contemplates the process of choosing a jobsite location where tool 200 is to be positioned and roughly locating base 500 at the location, then signaling base 500 to position tool 200 more precisely where it is desired in the manner discussed above. The primary means of rough positioning base 500 on a possibly crowded construction site decking, would be a worker simply picking up base 500 and moving it to the next task location.

The length/size dimensions of rails 510 and 520 will determine the size of the foot print or area of reach of tool 200 within base 500 given a particular base positioning within the work site. Rails 510, 520 may be very long so as to give the base a large range or area of positioning operation or the rails may be relatively shorter and so define less of a range or area of positioning, reduce weight, and provide a compact footprint for flexibility in crowded worksites.

As an alternative to a worker manually moving the base from one task location to the next and in order to increase the range within which automatic positioning can take place, the entire base may be supported on motorized tracks 555 like a vehicle so that the base can automatically be roughly moved to a new position on the worksite deck. When the base is a vehicle the base can receive a position signal and the vehicle can be automatically repositioned to a location that covers additional desired tool locations. At the new vehicle position, the tool can be more finely positioned as discussed above by motors 540X, 540Y and 540Z. At each vehicle stop, magnets 530 may be deployed. Alternatively, the vehicle may provide the final precise positioning of the tool with no further fine adjustment necessary. A further alternative might be to rely on the vehicle positioning of the tool as a substitute for the positioning of one or more of motors 540X and 540Y.

As mentioned total station 600 (e.g., a total station with uploaded CAD plans) positioned at a reference point on a jobsite can determine a desired tool location (e.g., a location where a hole should be drilled). In this case, total station 600 may include a visual indicator (e.g., a laser pointer that projects a light onto the work area exactly where or near where the tool is to be positioned). The visual indication on the site (e.g., on the metal decking) is an indication to an operator to move base 500 to that location for more precise tool positioning between base 500 and tool 200 as discussed above.

For example, a display on or remote from total station 600 (e.g, a cell phone) could include an uploaded CAD image. The CAD image could include the desired locations of work to be done (e.g., anchors to be installed). A user could use the display to choose the desired location. The laser pointer could point to the desired location projecting an image on the work site location near or at the desired position. Tool 200 and/or base 500 base could then be moved to that pointed-out, desired position for further base 500 tool position fine positioning.

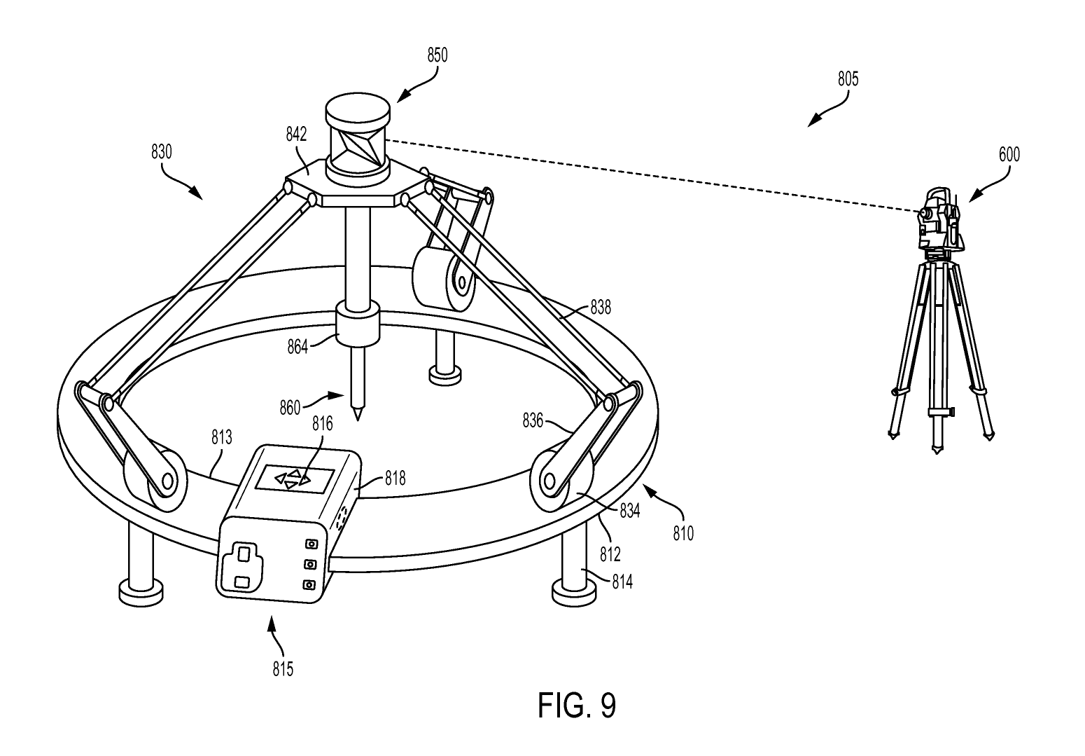

FIG. 9 shows an alternative embodiment to the motorized automatic tool positioning system of FIG. 8. Unlike base 500 of FIG. 8, the robotic base 805 of FIG. 9 resembles a delta robot type mechanism such as disclosed in US Patent Publication No. 2010/263471 and U.S. Pat. Nos. 4,806,068 and 5,333,514, each of which is wholly incorporated hereby by reference.

Robotic base 805 includes a support portion 810 and an articulating portion 830. Articulation portion 830 is supported on support portion 810. Support portion 810 includes a lower base 812 supported on legs 814. The length of legs 814 may be adjustable (e.g., telescopically). Lower base 812 can be structured as a peripheral support which includes an opening 813. Lower base 812 may also support a computer device 250 located in a control module 815 for controlling portions of articulating portion 830 as discussed in further detail below. Control module 815 may include a display (e.g., for showing arrows 816) or include a speaker 818 for communicating with a user. Control module 815 could also include a wireless receiver for communicating with computing device 250 and may be powered by battery or a plug. Furthermore, control module may include various other user input and output interfaces.

Articulating portion 830 includes a plurality of servo motors (preferably three) and at least one each of a crank arm 836 and position arm 838 (preferably three each). Articulation portion 830 also includes a platform 842 on which a power tool 200 can be mounted.

The parts of robotic base 804 are interrelated as follows. Each servo motor 834 is rotationally fixed to lower base 812. One end of crank arm 836 is pivotably secured to a rotor of servo motor 834 so that energizing of servo motor controls an angle of extension away from the servo motor rotor axis. A second end of each crank arm 836 is pivotably connected to a first end of each position arm 838. Furthermore, a second end of each position arm 838 is pivotably connected to platform 842. An electronic motor controller can control the angular positioning of each servo motor rotor to manipulate the position of platform 842 relative to support portion 810. Platform 842 may remain relatively parallel relative to lower base 813 as its position is manipulated because the crank arms 836 and position arms 838 may function similar to a four arm linkage or because the servo motor controller ensures it.

To utilize robotic base 805 as a tool positioner, a prism or light emitting or reflecting device 850 can be secured to platform 842. Furthermore a power tool 200 which, as discussed above, may include a marking device 860 can be attached to the bottom of platform 842. This disclosure anticipates a power tool 200 that is simply a non-motorized indicia generating device (e.g., a sprayer, pen, pencil, ink marker, etc.). An accessory connector 864 may be employed between platform 842 and power tool 200 so that multiple power tools 200 may be alternately, easily, and selectively secured to the bottom of platform 842.

When prism 850 is attached to robotic base 805 like prism 280 is attached to base 500 robotic base 805 has the same capabilities described above for base 500. In other words, a user can position a total station on the job site. A location of robotic base 805 can be determined relative to total station 800 as robotic base 805 includes at least the same features/capabilities described above for base 500. Furthermore, computing device 250 can receive and store basic position information about task locations relative to total station 800. Detailed CAD information on the computing device 250 can also be shown on a display 300 for additional context. It can be determined where robotic base 805 is relative to total station 800. Robotic base 805 can visually (e.g., on a display 300 which shows arrows 816) or audibly (e.g., via a speaker 818) indicate to a user in what direction robotic base 805 needs to be moved in to be moved toward the next task location. Robotic base 805 can then indicate to a user that robotic base 805 is at the next task location or roughly there. The user can then place robotic base 805 down on the worksite. Sitting on the worksite, legs 814 may be adjusted (e.g., automatically) to properly orient robotic base 805. Robotic base's 805 electronic controller can then manipulate platform 842 until tool 200 (e.g., marking device 860) is directly over the task location. Tool 200 can then extend through opening 813 and be repositioned to execute a task (e.g., drill a hole or mark a place where a hole should be drilled).

The description of the invention is merely exemplary in nature and, thus, variations that do not depart from the gist of the invention are intended to be within the scope of the invention. Such variations are not to be regarded as a departure from the scope of the invention.

1. A system for facilitating a tool operation, comprising:
a tool;
a remotely locatable device positioned on the tool;
a computing device capable of determining a point location of the remotely locatable device relative to the computing device, the computer device also capable of receive and storing data representing at least one work point location where the tool is to perform a construction operation;
a support mechanism for supporting and automatically positioning the tool, the support device including a signal receiver for receiving a signal from the computer device;
wherein the support device receives a signal from the computing device to instruct the support mechanism to move the tool or the remotely locatable device toward the at least one work point location.

2. The system of claim 1, wherein the system includes a speaker or a display and generates a visual or audible signal that indicates to a user that the remotely locatable device is close to the at least one work point location.

3. The system of claim 1, wherein the system includes a speaker or display and generates a visual or audible signal to instruct a user holding the support mechanism which way to move the tool to position the tool closer to the at least one work point location.

4. The system of claim 3, wherein the visual or audible signal is one of a visual arrow on the display and an audible voice instructing a user to move the tool right, left, backward, or forward.

5. The system of claim 4, wherein the display is one or more displays positioned on one of the user, the support mechanism, the computer device, or the tool.

6. The system of claim 5, wherein the one or more displays also includes a remote hand held display wirelessly communicating with the computer device.

7. The system of claim 6, wherein the operator may use the remote display to chose the at least one location and be directed to the at least one location by the computer device.

8. The system of claim 1, wherein the support mechanism includes a motor.

9. The system of claim 1, wherein the tool includes a motor.

10. A system for facilitating a tool operation, comprising:
a tool;
a remotely locatable device positioned on the tool;
a computing device capable of determining a point location of the remotely locatable device relative to the computing device, the computer device also capable of receive and storing data representing at least one work point location where the tool is to perform a construction operation;
a support mechanism for supporting and automatically positioning the tool, the support device includes a receiver for receiving a signal from the computer device;
wherein the receiver receives a signal from the computing device; and wherein the system indicates to a user a necessary direction in which to move the support mechanism so that the support mechanism will be closer to or at the work point location.

11. The system of claim 10, wherein the system includes a speaker or a display and generates a visual or audible signal that indicates to a user that the remotely locatable device is close to the at least one work point location.

12. The system of claim 10, wherein the system includes a speaker or display and generates a visual or audible signal to instruct a user holding the support mechanism which way to move the tool to position the tool closer to the at least one work point location.

13. The system of claim 12, wherein the visual or audible signal is one of a visual arrow on the display and an audible voice instructing a user to move the tool right, left, backward, or forward.

14. The system of claim 13, wherein the display is one or more displays positioned on one of the user, the support mechanism, the computer device, or the tool.

15. The system of claim 14, wherein the one or more displays also includes a remote hand held display wirelessly communicating with the computer device.

16. The system of claim 15, wherein the operator may use the remote display to chose the at least one location and be directed to the at least one location by the computer device.

17. The system of claim 10, wherein the support mechanism includes a motor.

18. The system of claim 10, wherein the tool includes a motor.
